(19) United States
(12) Patent Application Publication
(10) Pub. No.: US 2014/0084114 A1
(43) Pub. Date: Mar. 27, 2014

(54) VTOL Aircraft with Propeller tiltable around two Axes and a retractable Rotor

(71) Applicant: Ingo Valentin, Elm Grove, WI (US)

(72) Inventor: Ingo Valentin, Elm Grove, WI (US)

(73) Assignee: Ingo Valentin, Elm Grove, WI (US)

(21) Appl. No.: 13/626,008

(22) Filed: Sep. 25, 2012

(51) Int. Cl. B64C 27/30; B64C 27/26; B64C 27/28; B64C 29/00

(52) U.S. Cl. CPC B64C 27/30; B64C 29/0016; B64C 27/26; B64C 27/28
USPC 244/7 R

(57) ABSTRACT

A VTOL aircraft has a rotor, wings, and a propeller providing thrust for take-off and landing and horizontal flight. The propeller, attached through a joint mechanism to the aircraft, is continuously tiltable around to axes, providing the anti-torque forces for the rotor and thrust forces for lifting the aircraft and for horizontal flight. The hubs of rotor blade sets are rotatable to each other for alignment. The rotor assembly, attached to a moveable linkage mechanism, is tiltable in or against the direction of flight and movable towards to or into the fuselage. The folded and retracted rotor reduces the air drag and the high thrust of the propeller increase the speed of winged flight. The flexibility and lower weight of the drive are preferably achieved with an advanced hydrostatic drivetrain.

### BACKGROUND OF THE INVENTION

1. Technical Field

The invention relates generally to VTOL aircrafts or helicopters which take-off and land vertically, and in particular to innovations which increase the maximum speed and range of the aircraft, and reduce the weight, size, and complexity of the drive system.

Helicopters, as a specific type of VTOL aircraft, are well known in the art and consist typically of a rotor for lifting the aircraft and a propeller providing the counter moment for the rotor. A forward tilting of the helicopter results in a horizontal component of the rotor force, providing the thrust for horizontal flight. Although highly advantageous for various applications, helicopters have a very limited speed and travel range, high fuel consumption and low payloads, and are mechanically complex and costly. The speed is limited by the velocity of the tip of the rotor blade turning in the flight direction, where the circumferential velocity of the rotor and the speed of the aircraft become too high for maintaining sufficient lift forces of the rotor.

Attempts have been made to increase the maximum speed of helicopters by adding wings to the aircraft to provide additional lifting forces at higher speeds to compensate for the declining lifting force of the rotor and a propeller providing thrust for horizontal flight. However, the more than proportionally increasing drag forces of the idling rotor and increase in weight reduce the possible gains in speed and efficiency of winged flight significantly.

2. Background Art

As disclosed in U.S. Pat. No. 5,738,301, an additional propeller, with the centerline parallel to the centerline of the fuselage, is attached for providing thrust for high speeds during horizontal flight. The two propellers required, one providing the counter moment for the rotor and one providing thrust for horizontal flight, increase the mechanical complexity of the drive system, weight, air drag, and costs while reducing the efficiency.

Another helicopter concept, as disclosed in U.S. Pat. No. 8,070,089 B2, has one propeller on each wing providing the counter moment to the rotor by higher thrust of the propeller to counter the torque of the rotor and utilizing the thrust of both propellers for high speeds during horizontal flight. The propellers are not tiltable into a vertical position for increasing the lifting capacity of the drive system, increasing the weight, cost, and efficiency of such aircraft.

The V-22 as another VTOL concept, utilizes tiltable, counter-rotating propeller units at each wing. The rotor/propeller provide high thrust during take-off with low speed of the aircraft and lower thrust at high speed of horizontal flight. The wide aerodynamic operating profile required from the rotor/propeller unit does not provide the efficiency of an rotor or propeller specifically designed for their purpose, i.e. thrust from the rotor for lifting the aircraft and pushing force from the propeller for horizontal flight. The control of the aircraft is more difficult than that of an airplane or helicopter and the drive system is complex, heavy, costly, and less efficient.

### VTOL Propeller Mechanism

In one known VTOL aircraft with tiltable propeller, disclosed in U.S. Pat. No. 3,426,982, the propeller mechanism, consisting of one propeller on each side of the fuselage, is tiltable around one axis to provide lifting forces when the axis of the propellers are in a vertical position and push forces for horizontal flight when in a horizontal position. The anti-torque function of the propeller mechanism is achieved by means for orienting the axis of rotation of the propeller means in oppositely inclined relation when in the vertical position for counteracting torque exerted on the body by the driving rotor.

During horizontal flight, this anti-torque concept of oppositely inclined propeller axis results in significant difficulties in controlling the roll movement of the aircraft. The conventional geared drive and tilt mechanism for the two propellers, increases the weight and necessitates placing the propeller in the downwash area of the rotor. The arrangement reduces the aerodynamic efficiency and control of the aircraft during the transition from vertical to horizontal flight and vice versa.

In another VTOL aircraft with a tiltable propeller unit, disclosed in U.S. Pat. No. 8,181,903, a tiltable stabilizer drive combination provides lifting forces for take-off when the propeller axis is in vertical position and thrust for horizontal flight when in horizontal position. A tilting around an axis parallel to the axis of the fuselage of the aircraft is neither required, since the counter torques of the rotors balance each other, nor claimed.

In another VTOL aircraft with a tiltable propeller unit, disclosed in U.S. Pat. No. 7,143,973, a centrally mounted tiltable engine and rotor assembly provides thrust for take-off and horizontal flight. Counter-rotating propellers are utilized to eliminate torque effects. A large thrust force and rotor diameter is required for take-off reducing the aerodynamic efficiency of the rotor/propeller during horizontal flight. The large propeller diameters result in a significant distance between the thrust of the propeller and the center of drag of the aircraft, resulting in unfavorable flight control conditions and an increase in drag and loss in efficiency.

### VTOL Rotor Folding And Retract Mechanism

Folding: In one known foldable rotor mechanism, disclosed in U.S. Pat. No. 4,436,483, a power blade fold mechanism, in which the blade is pivotally attached to the central hub, and locked by at least one pin in its spread position. The mechanism is heavier and more complex since the balancing centrifugal force of the opposite blade is transmitted through joints, the CG not concentric to the hub and aerodynamic forces in rotational direction are not symmetrical.

Retracting: In one known retractable rotor mechanism, disclosed in U.S. Pat. No. 5,149,013, the rotor, swashplate and pitch change rods are retracted and extended moved axially along the rotor drive shaft towards the fuselage to lower the height of the aircraft. The mechanism changes the distance between the turbine/gear box assembly and the rotor system and is therefore very complex, heavy, and costly.

Retracting: In one known retractable rotor mechanism, disclosed in U.S. Pat. No. 5,209,429, the rotor, swashplate, pitch change mechanism are moved axially along the support mast towards the fuselage to lower the height of the aircraft. The mechanism changes the distance between the turbine/gear box assembly and the rotor system and is therefore very complex, heavy, and costly.

It is therefore an object of the invention to provide a simplified drive system for VTOL aircrafts to increase the range and cruise speed, and to reduce the weight, costs of procurement and operational costs significantly.

### BRIEF SUMMARY OF THE INVENTION

The present invention is based on a novel hydrostatic drive system for VTOL aircraft, enabling a propeller assembly being tiltable around two axes and a foldable, retractable rotor mechanism. In this configuration, all thrust forces for operating the aircraft provided by the rotor and the propeller and are fully available during take-off, transition, and horizontal flight, improving fuel efficiency and flight control, while reducing weight, space requirements and costs. Advanced hydrostatic drive systems allow for new aircraft concepts, because of their very high power density (power/weight ratio), easy and fast controllability of torque and speed, flexibility in transmitting the power, and freedom of placing the drivetrain components independently from each other.

The VTOL aircraft utilizes a rotor and a propeller to provide thrust during vertical take-off. The propeller is moving continuously from a substantially vertical position into a horizontal position, initiating the transition to horizontal flight while providing forces to counter the moment of the rotor. With increasing horizontal speed, the aerodynamic lifting forces of small wings provide sufficient vertical forces to substitute the lifting forces of the rotor. At higher horizontal speeds, the rotor is folded into an aerodynamically favorable position and retracted towards or into the fuselage to minimize drag losses.

Propeller movable around two axes: The first axis of rotation of the propeller assembly allows tilting the propeller axis from a vertical position, lifting the aircraft, to a horizontal position, where the axis is substantially parallel to the axis of the fuselage, providing thrust for horizontal flight. The second axis of rotation of the propeller assembly allows tilting the propeller axis around the axis of the fuselage, substantially perpendicular to the vertical plane of the first axis, providing propeller thrust forces to counter the moment of the rotor. Due to the high thrust of the propeller, the tilt angle required to obtain the counter moment of the rotor is small, resulting in high remaining thrust component for lifting and high speed cruising of the aircraft.

Foldable and retractable rotor: The rotor is located in front of the CG (Center of Gravity) of the aircraft to provide a counter force to the lifting force of the propeller in the rear of the aircraft.

The preferably ridged rotor, not designed being efficient at high horizontal speed, is driven by a hydrostatic motor, provided by pressurized fluid through the folding mechanism, retracting the rotor/hydraulic motor assembly towards the fuselage.

The foldable rotor consists of at least two blade sets, having a common hub. The blades are equally spaced to each other and locked by a mechanism during operation. When folding the rotor, the mechanism is unlocked, the blade sets are rotatable moved in a position where the sets are substantially parallel to each other, and locked again in this new position.

### BRIEF DESCRIPTION OF THE DRAWINGS

The features of the invention which are believed to be novel are set forth with particularity in the appended claims. The invention, together with the further objects and advantages thereof, may best be understood by reference to the following description taken in conjunction with the accompanying drawings, wherein like reference numerals identify like elements, and wherein:

FIG. 1 is a side view of the conceptual presentation of the VTOL aircraft in accordance with the invention.

FIG. 2 is the rear view of the conceptual presentation of the VTOL aircraft in accordance with the invention.

FIG. 3 is a simplified presentation of the propeller, moveable around two axes, in a substantially vertical position in accordance with one embodiment of the propeller adjustment mechanism as shown in FIG. 1.

FIG. 4 is a simplified presentation of the propeller, moveable around two axes, in a substantially horizontal position in accordance with another embodiment of the propeller adjustment mechanism as shown in FIG. 1.

FIG. 5 is a partial perspective view of the rotor folding mechanism and the rotor retracting mechanism in extended, operational position.

FIG. 6 is a side view of the conceptual presentation of the VTOL aircraft with the rotor in folded and the propeller in horizontal position as applied during horizontal flight.

FIG. 7 is a partial perspective view of the joint position adjustment of the retracting mechanism with a longitudinal slider means.

FIG. 7a is a partial perspective view of the joint position adjustment of the retracting mechanism with a rotatable eccentric means.

FIG. 8 is a side view of the rotor locking mechanism with gear tooth.

FIG. 9 is a partial side view of a scissor-type retracting mechanism.

### DETAILED DESCRIPTION OF THE PREFERRED EMBODIMENTS

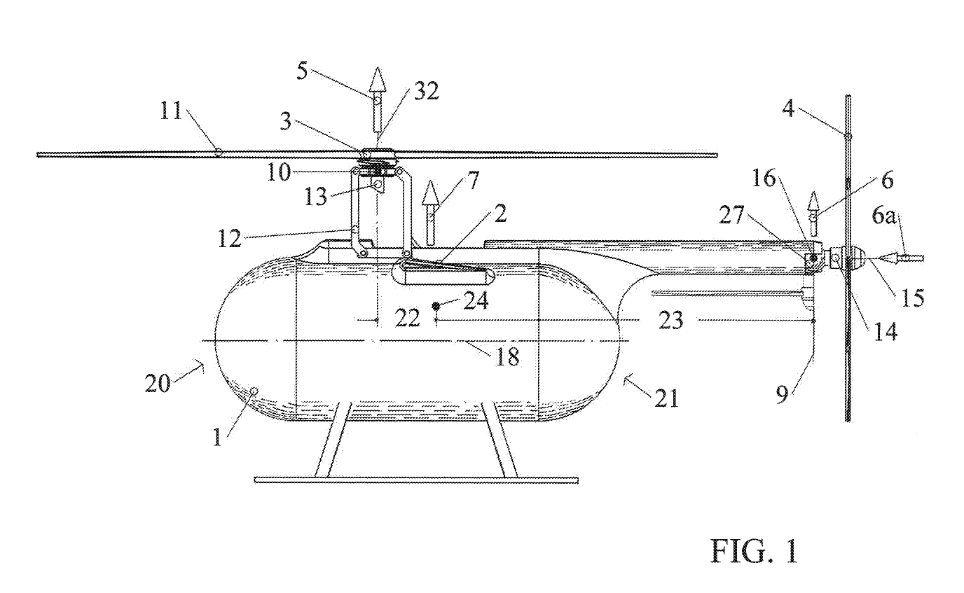

The aircraft, shown in FIG. 1, consists of fuselage 1, wings 2, at least one rotor assembly 3 and at least one propeller assembly 4 as drive system. Rotor and propeller provide the thrust forces 5 and 6 during vertical take-off and landing (VTOL). During the transition, the propeller, continuously tilting in a horizontal position, provides thrust forces for horizontal flight, and the rotor thrust force 5 are increasingly substituted by the lifting force 7 of the wing. To achieve the VTOL and winged flight capability, the aircraft includes the following new features:

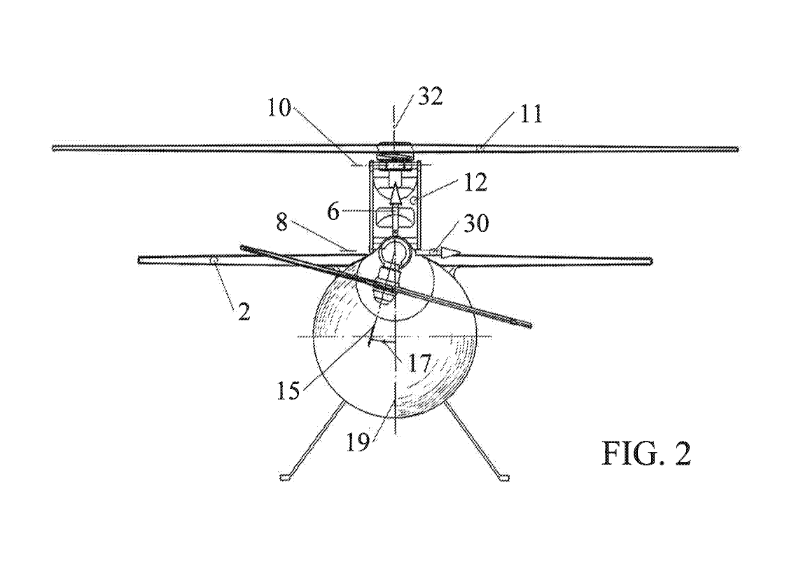

1. The propeller is tiltable around two axis 8 (FIG. 2) and 9 (FIG. 1) providing the vertical lifting force 6 for VTOL and thrust force 6a for horizontal flight, and to provide a thrust force in horizontal direction for countering the moment of the rotor.

2. Rotor assembly 3 is tiltable around at least one axis 10 (FIG. 2) improving the trimming maneuverability, and auto gyro conditions of the aircraft.

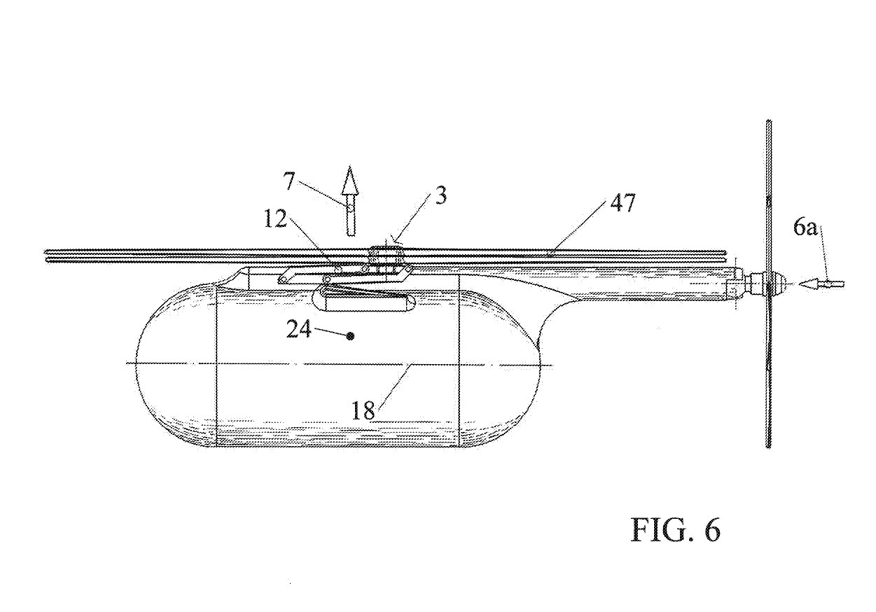

3. Blades 11 of the rotor assembly 3 can be aligned to the fuselage and locked with each other, reducing the aerodynamic drag. (FIG. 6)

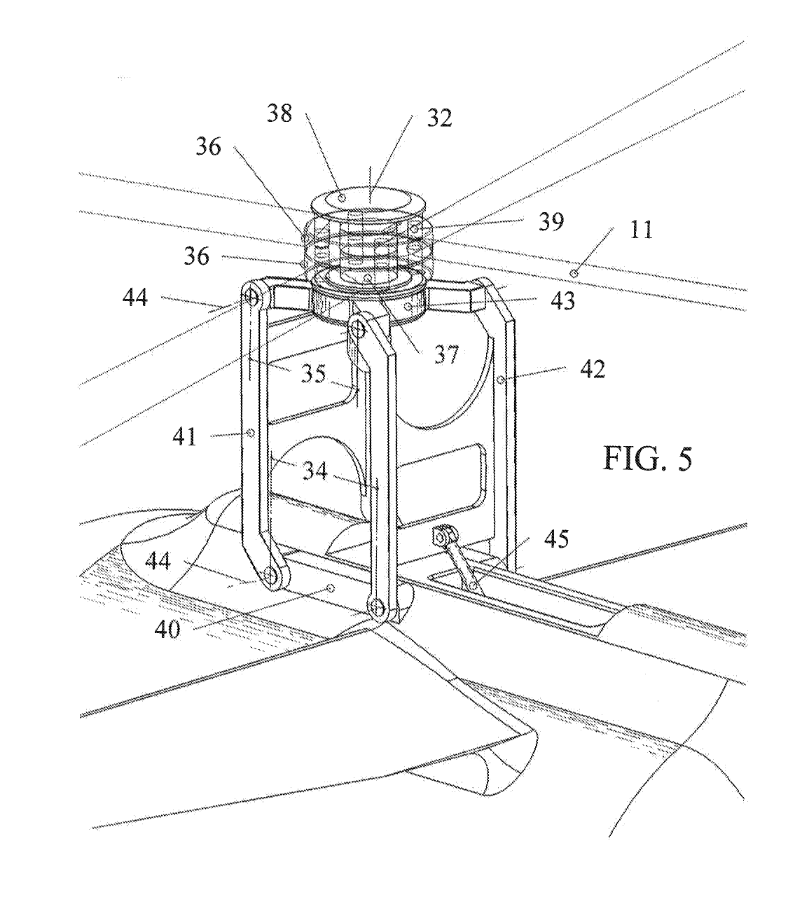

4. Rotor assembly 3 is mounted on retract mechanism 12 (FIG. 5) for moving the rotor closer to or into fuselage 1 to minimize aerodynamic drag and to reduce the space requirements for storage and transportation. (FIG. 6)

The increased operational requirements for rotor and propeller can be fulfilled with conventional geared systems, but preferably with hydraulic motors 13 and 14 (FIG. 1) of an advanced hydrostatic drivetrain, offering very high power density, continuous adjustability, and the flexibility of transmitting the power through tubes and hoses, allowing to place and operate the drive train components independently from each other. The size of the illustrated drivetrain components approximates actual dimensions.

### Tiltable Propeller

The propeller axis 15 and 16 are tiltable and provide two degrees of freedom (DOF). The first DOF allows tilting the propeller axis 15 from a horizontal position, parallel to centerline 18 of fuselage 1, into a vertical position, substantially parallel to the axis of the rotor, into plane 19 (FIG. 2). The thrust force 6 of the propeller in its vertical position reduces the required thrust force 5 of the rotor. Rotor assembly 3 is positioned towards the front end 20 of the fuselage and propeller assembly 4 at the opposite end 21 near the end of the fuselage. The moments of thrust forces 5 and 6 multiplied by their distance 22 and 23 from the center of gravity (CG) 24 balance or nearly balance each other.

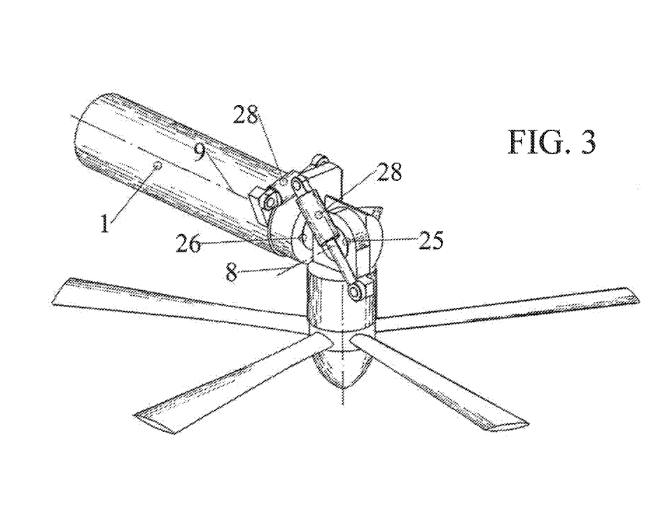

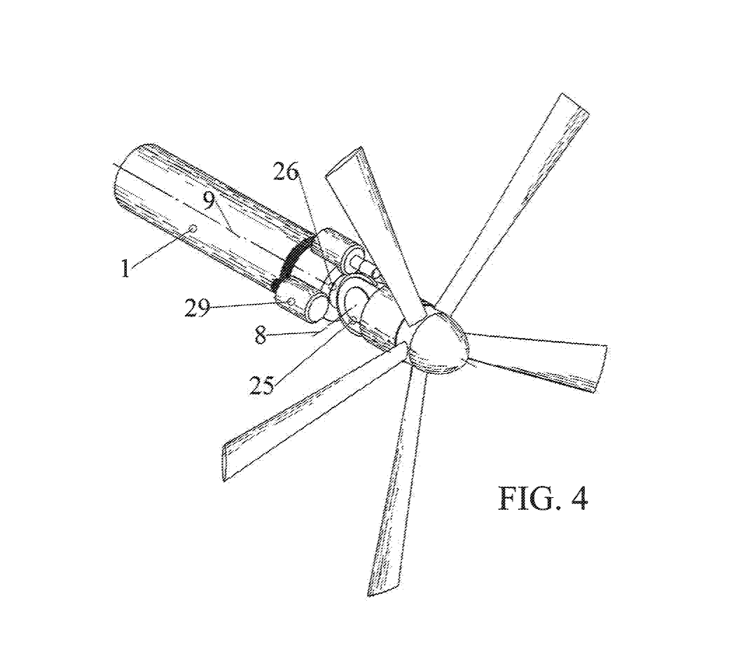

The second DOF allows tilting the propeller axis 15 out of plane 19. The tilt angle 17 is provided by the rotational joints 25 and 26 (FIG. 3), one for each axis 8 and 9, or by a spherical joint 27 as shown in FIG. 1 for both axes, actuated through devices with an axial 28 (FIG. 3) or rotational movement 29 (FIG. 4)

The first DOF transforms the propeller thrust for lifting 6 into thrust for pushing 6a during horizontal flight. The second DOF points the thrust force slightly sidewise, creating a force 30 (FIG. 2) balancing the counter moment of the rotor with a force component in horizontal direction. The independent, continuous adjustability of both axes allows for an accurately controlled transition from rotor supported to wing supported flight, and provides in addition the function of the horizontal and vertical stabilizer of an airplane.

### Tiltable Rotor

The Axis 32 of rotor assembly 3 has one DOF, allowing the tilting of the axis forward and backward in plane 19 (FIG. 2). The DOF improves the maneuverability and trimming of the aircraft and provides the conditions to operate the aircraft also in a gyroplane mode where the rotor is slightly tilted backward improving the airflow, driving the rotor, generating rotation and lifting forces for the aircraft without driving the rotor mechanically.

### Alignment of Rotor Blades

At cruise speed, the lifting force 7 is provided by the wings 2 and thrust 5 from rotor 3 is not required. To minimize drag and interference with the air flow over the wings, the rotor blades 11 or sets of rotor blades 47 are aligned with each other and rotated into a position substantially parallel to the centerline of the fuselage 18 (FIG. 6)

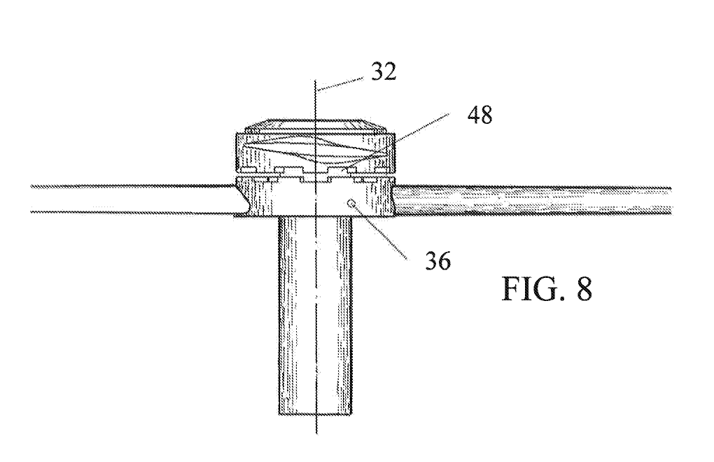

The sets of rotor blades 47 (FIG. 5), consisting of two opposing blades 11 with a common center hub 36, are rotatable mounted on the drive shaft 37 of hydraulic motor 13. During operation, the locking plate 38 locks the sets with the blades equally spaced to each other. When not utilized, the sets of blades 47 are unlocked, rotated into a position where the blades are aligned to each other and then locked again. The locking function is obtained through pins 39 at the locking plate 38 or by a tooth mechanism 48 (FIG. 8) at the faces of the common center hub 36 in contact with each other. The disengagement of the locking mechanism is obtained by retracting the pins 39 out of the opposing hub 36 or by separating the center hubs in axial direction from each other.

### Retractable Rotor

The set of rotor blades 47, preferably aligned to centerline 18 of the aircraft, are retracted closer to or into the fuselage to reduce drag and space requirements as shown in FIG. 6.

The rotor assembly 3 is attached to a retract mechanism 12 (FIG. 1, FIG. 6) maintaining the rotor blades in a parallel or nearly parallel position to the fuselage when extending or retracting the rotor. The retract mechanism consists of linkage plates 41 and 42 (FIG. 5), connecting the rotor drive mechanism 43 with joint plate 40 of the fuselage. Each linkage plate is rotatable connected at one end with the joint plate and at the opposing end with drive mechanism. The centerlines 44 of linkage plates 41 and 42, determining the points of rotation at joint plate 40 of the fuselage and rotor drive mechanism 43, are parallel or nearly parallel to each other, allowing the rotor blade sets 47 to be retracted and extended in a substantially parallel position towards or into the fuselage. The retraction movement allows locating the weight 46 of the rotor assembly 3 and the retract mechanism 12 at or closer to the center of gravity (CG) 24 of the aircraft or the center of the lifting forces 7 of the wing to ease trimming (FIG. 6).

In accordance with one principle aspect of the invention, the distances 34 and 35 of the joints at centerlines 44 are equal, providing a non-tilting movement of drive mechanism 43 when retracting or extending the rotor. Unequal distances 34 and 35 of centerlines 44 result in a tilting movement of rotor assembly 3 around axis 10 when moving the retract mechanism 12 in its substantially vertical position, directing the thrust of the rotor in or against the direction of flight, allowing for improved control of the aircraft. The retract mechanism is actuated through device 45 with an axial movement or by a device with rotational movement at one of the centerlines 44 of linking plates 41 and 42.

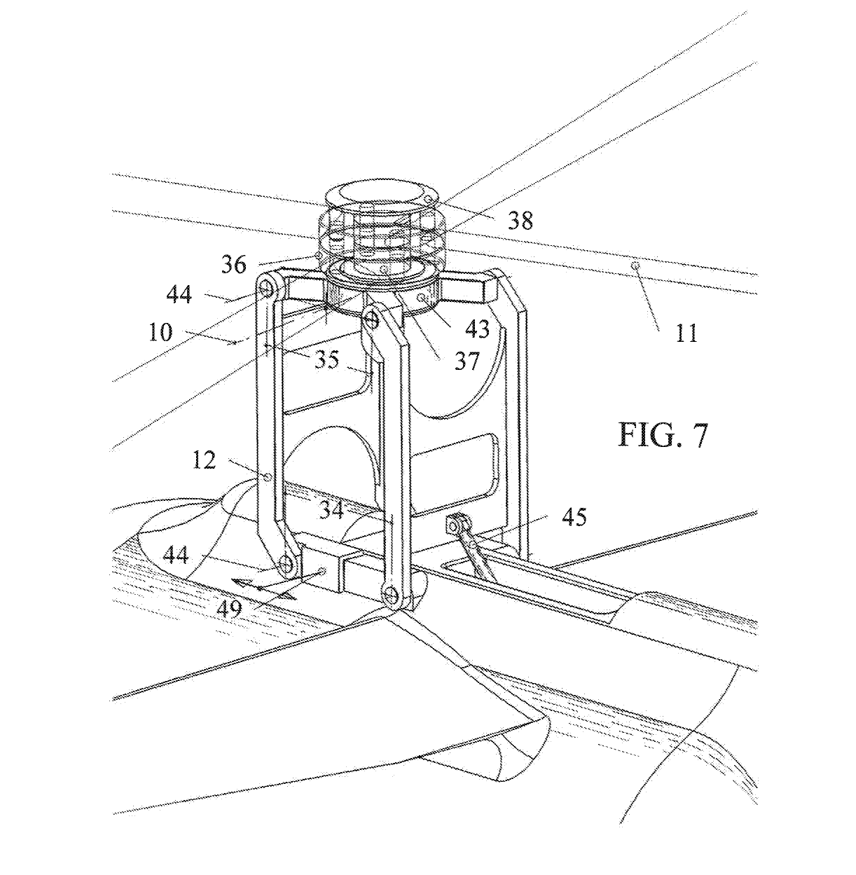

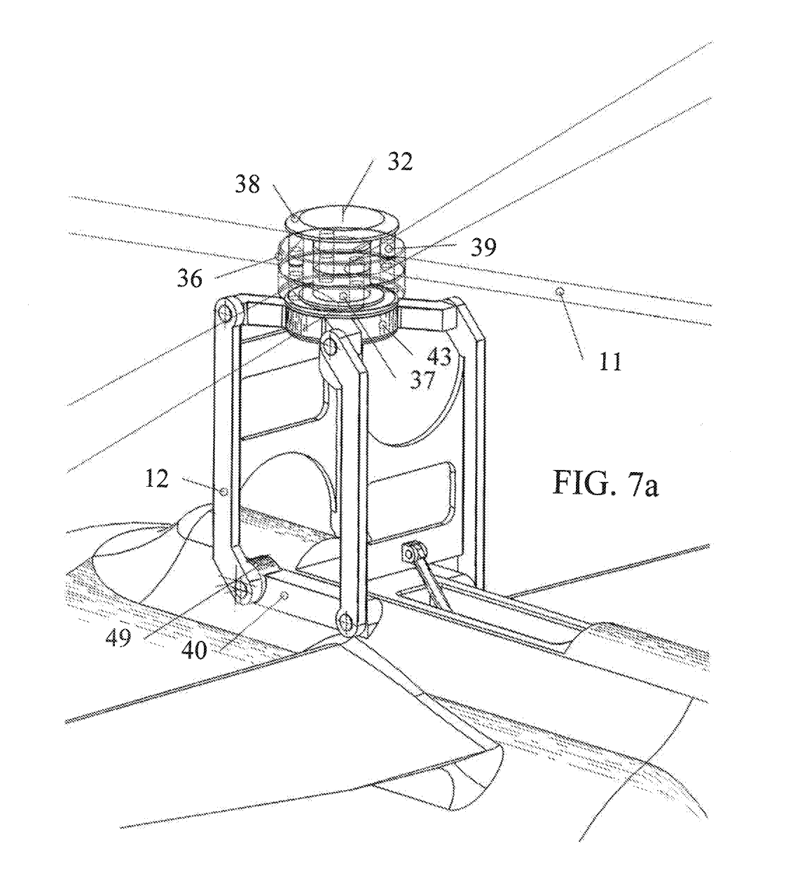

In accordance with still another aspect of the invention, the distance 34 of the joints at rotor drive 43 or distance 35 of the joints at joint plate 40 are continuously adjustable (FIG. 7, FIG. 7a), resulting in a tilting movement of rotor assembly 3 around axis 10 for changing the direction of the thrust of the rotor. The adjustment is obtained by moving sliding joint block 49 on joint plate 40 (FIG. 7), or by a rotating eccentric joint bushing 50 around centerline 44 (FIG. 7a).

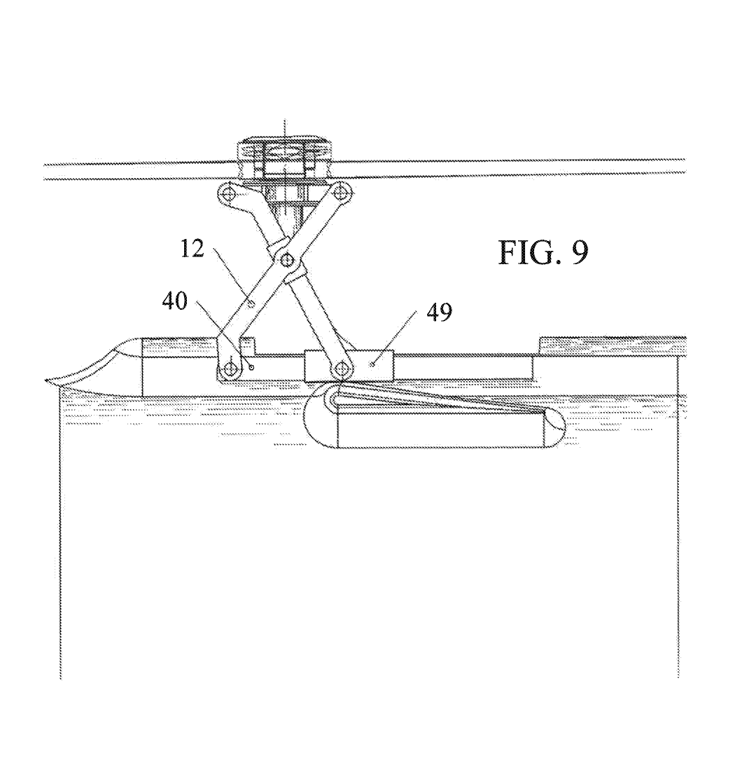

Instead of substantially parallel moving linking plates 41 and 42 a well-known scissor-type linking arrangement is utilized to retract the rotor assembly 3 (FIG. 9). Unequal distances 34 and 35 of centerlines 44 to obtain one DOF for tilting the rotor, as shown in FIG. 7, FIG. 7a, are also applicable for the scissor mechanism.

While preferred embodiments have been illustrated and described, it should be understood that changes and modifications can be made thereto without departing from the invention in its broadest aspects. Various features of the invention are defined in the following claims.

What is claimed is:

1. An aircraft comprising:
a fuselage;
at least one rotor unit and one propeller unit for lifting the aircraft off the ground, said propeller unit having a propeller, a drive unit for said propeller and a joint means, said joint means comprising a substantial spherical joint means for connecting said propeller unit to said fuselage,
said joint means allows for substantially rotating the axis of said drive unit around a vertical axis, parallel to the centerline of said rotor unit, and a horizontal axis, perpendicular to the centerline of said fuselage.

2. An aircraft comprising:
a fuselage;
at least one rotor unit and one propeller unit for lifting the aircraft off the ground,
said propeller unit having a propeller, a drive unit for said propeller and a joint means,
said joint means consisting of a cylindrical joint, having an axis parallel to the centerline of said fuselage, and a second cylindrical joint, having an axis perpendicular to said axis parallel to the centerline of said fuselage,
said joint means allows for substantially rotating the axis of said drive unit around a vertical axis, parallel to the centerline of said rotor unit, and a horizontal axis, perpendicular to the centerline of said fuselage.

3. An aircraft comprising:
a fuselage;
at least one rotor unit and one propeller unit for lifting the aircraft off the ground,
a rotor drive unit having a rotor, and a drive unit for said rotor,
a retract mechanism comprising a rotor drive housing, a joint plate at said fuselage, and a first and second link plate for connecting said rotor drive housing with said joint plate,
said rotor drive unit being connected to said rotor drive housing of said retract mechanism,
said rotor drive housing, said first and second link plates, and said joint plate having a first and a second joint means with centerlines spaced from and parallel to each other,
said centerlines of said joint plates of said fuselage are located in a horizontal plane and perpendicular to the centerline of said fuselage,
said first joint means of said first link plate is connected to said first joint means of said rotor drive housing and said second joint means of said link plate is connected to said first joint means of said joint plate,
said first joint means of said second link plate is connected to said first joint means of said rotor drive housing and said second joint means of said link plate is connected to said second joint means of said joint plate,
said space of said centerlines of said rotor driving house and said joint plate is equal or nearly equal, allowing to retract said rotor towards said fuselage with said centerline of said drive unit in its vertical or nearly vertical position.

4. An aircraft as defined in claim 3, wherein the
said first joint means of said first link plate is connected to said first joint means of said rotor drive housing and said second joint means of said link plate is connected to said second joint means of said joint plate,
said first joint means of said second link plate is connected to said first joint means of said rotor drive housing and said second joint means of said link plate is connected to said first joint means of said joint plate.

5. An aircraft as defined in claims 3 and 4, wherein the distance between the centerlines of the first joint means and the second joint means at said joint plate is continuously adjustable.

6. An aircraft as defined in claims 3 and 4, wherein the distance between the centerlines of the first joint means and the second joint means at said rotor drive housing is continuously adjustable.

7. An aircraft comprising:
a fuselage;
at least one rotor unit and one propeller unit for lifting the aircraft off the ground, drive unit having a rotor, and a drive unit for said rotor,
a rotor consisting of more than one rotor set, having a common center with blades opposing each other,
a locking mechanism for locking said rotor sets in a position where said blades in rotational direction are equally spaced to or aligned with each other,
said locking mechanism comprising a locking plate with at least one locking pin slide ably mounted in bores of said common centers concentric to each other and parallel to the centerline of the said common centers, allowing a rotational movement of said blade sets to each other when said locking pin has entered the concentric bore of one common center, and preventing the rotational movement when said locking pin enters the concentric bores of the adjacent common center in addition.

8. An aircraft as defined in claim 7, wherein the axial faces of the common centers are profiled that they interlock when in contact with each other and are unlocked when the common centers are substantially separated to each other in axial direction.
